(19) United States
(12) Patent Application Publication
(10) Pub. No.: US 2009/0179878 A1
(43) Pub. Date: Jul. 16, 2009

(54) DISPLAY DRIVE CIRCUIT AND METHOD FOR DISPLAYING AN IMAGE WITH AN IMAGE DATA SIGNAL SPLIT

(75) Inventor: Hisashi NAKAMURA, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI SEMICONDUCTOR CO., LTD., Tokyo (JP)

(21) Appl. No.: 12/333,349

(22) Filed: Dec. 12, 2008

(30) Foreign Application Priority Data
Jan. 11, 2008 (JP) 2008-004870

(51) Int. Cl. G06F 3/038

(52) U.S. Cl. 345/204

(57) ABSTRACT

A display drive circuit includes a line memory which an image data signal is written into and read out from on a pixel-by-pixel basis. The line memory has its total storage capacity corresponding to at least a horizontal period of the image data signal. The display drive circuit also includes a controller that commands the line memory to alternately write and read out the image data signal. The controller controls the line memory so as to commence to read out, with the image data signal split into sets of split image data signals, the split image data signals of each horizontal period from the line memory after having written into the line memory the pixel data signals output as a first signal of the split image data signals in the horizontal period in respect of each set of split image signals.

### BACKGROUND OF THE INVENTION

1. Field of the Invention

The present invention relates to a circuit for driving a display device, and more particularly to a circuit for driving an image display device by splitting an input image signal to output split image signals to the image display device. The present invention also relates to a method of driving an image display device by splitting an input image signal to output split image signals to the image display device.

2. Description of the Background Art

In the apparatus dealing with imagewise data, such as an image display device, data information to be transferred is voluminous. In order to solve this problem, such a technique has been developed, for example, in which the display screen of an image display device, such as a liquid crystal display (LCD) panel, is electronically split into sections so as to transfer image data at a lower rate to the sections.

For example, in the drive circuit for a display apparatus, disclosed by Japanese patent laid-open publication No. 210359/1993 to Tanaka et al., a liquid crystal panel is divided into a left and a right half portion, to each of which data are transferred. The drive circuit has four line memories having the sum total of data storage capacity corresponding to two horizontal scanning lines of an image to be displayed. The line data of the first line are split into left and right pixel lines of data on a display screen so as to be written into two of the line memories (first and second line memories, respectively) corresponding to a single horizontal line. For the line data of the second line, a changeover switch is operative to switch the first and second line memories to the remaining line memories, i.e. third and fourth line memories, to which the line data are destined for writing. The line data of the second line are similarly split into left and right pixel lines of data on the display screen to be written into the third and fourth line memories, respectively, to thus forming another single horizontal line.

During the time when the data of the second line are being written into the third and fourth line memories, the left and right pixel lines of data, written into the first and second line memories, respectively, are read out and output via an output buffer to a liquid crystal panel. The repetition of this sequence of operation causes the rate of data transmission to the liquid crystal panel to be slowed down, thus allowing a low-speed source driver to be used.

The drive circuit for a display apparatus disclosed by Japanese patent laid-open publication 2001-27886 to Tsuchida et al., has two line memories having the sum total of the data storage capacity corresponding to one horizontal line. At a time point when some amount of data has been written into the two line memories, split data are read out from the two line memories while writing data into one of the line memories.

In the circuit disclosed by Tanaka et al., the memory operation is switched between writing and readout operations, and hence the line memories require the data storage capacity corresponding to the sum total of the two lines. An example of timing controller with its function lower has its line memories taking up a space equal to about 20% of the logics, excluding the I/O (input/output) section. The memory capacity significantly affects its manufacturing cost. For this reason, it has been a desideratum to reduce the memory capacity and hence the manufacturing cost.

With the circuit disclosed by Tsuchida et al., the two line memories sufficiently have the sum total storage capacity corresponding to the data quantity of a single horizontal line. However, for one of the line memories, writing and readout operations are made at the same timing. In order to implement such operations, it is presumably necessary to use a dual-port RAM (Random Access Memory) with which data are read out from one of two terminals and data are also written on the other terminal. Tsuchida et al. is silent about which type of RAMs is appropriate for the line memories. However, in order to implement the operations described in Tsuchida et al., it is presumably necessary to use the dual port type of RAM.

However, the dual-port RAM has its circuit size about twice as large as a commonly-used type of RAM with which readout and writing are carried out at distinct timings. It is therefore not possible to reduce the manufacturing cost with the use of the circuit including dual-port RAMs.

### SUMMARY OF THE INVENTION

It is therefore an object of the present invention to provide a circuit and a method for driving a display device to implement splitting and outputting image data signals with a reduced manufacturing cost.

In accordance with the present invention, a display drive circuit for driving an image display device with a plurality of sets of split image signals produced by splitting an input image data signal in a horizontal period containing a predetermined number of pixel data signals for displaying an image comprises: a memory having a total memory capacity corresponding to at least the horizontal period for storing the pixel data signals and developing the pixel data signals stored; and a controller for controlling the memory to alternately write in and read out the pixel data signals to and from the memory, the controller controlling the memory to commence to read out the pixel data signals of the horizontal period from the memory after having written into the memory the pixel data signals output as a first signal of the split image data signals in the horizontal period in respect of each of the plurality of sets of split image signals.

In accordance with the present invention, a method of driving an image display device with a plurality of sets of split image signals produced by splitting an input image data signal in a horizontal period containing a predetermined number of pixel data signals for displaying an image comprises: a storage step of writing the pixel data signals of the horizontal period on a pixel-by-pixel basis into a memory, and of reading out the pixel data signals stored from the memory; a step of controlling the storage step to alternately write in and read out the pixel data signals; and a step of controlling the storage step to commence to read out the pixel data signals of the horizontal period after having written the pixel data signals output as a first signal of the split image data signals in the horizontal period in respect of each of the plurality of sets of split image signals.

According to the present invention, the storage capacity of the memory corresponds to one horizontal period of the image data signals suffices. Consequently, the image data signals can be split and output with a storage capacity corresponding to one-half of that of the conventional memory. In addition, there is provided a controller that controls the memory so that, with the image data signals split into multiple sets of the split image data signals, the readout of the image data signals for each horizontal period from the memory will be started after having written the pixel data signals output at the top of the split image data signals generated from the image data signal corresponding to one horizontal period. The controller controls the memory to alternately store and develop the pixel data signals. It is therefore unnecessary to use a memory device having its storage capacity larger, and hence to reduce the manufacturing cost in implementing the display drive circuit and the display driving method.

### BRIEF DESCRIPTION OF THE DRAWINGS

The objects and features of the present invention will become more apparent from consideration of the following detailed description taken in conjunction with the accompanying drawings in which:

FIG. 1 is a schematic circuit diagram showing the constitution of a preferred embodiment of a display drive circuit according to the present invention;

FIG. 2 is a timing chart for illustrating the operational sequence of the embodiment shown in FIG. 1;

FIG. 3 is a schematic circuit diagram showing the overall constitution of another preferred embodiment of the display drive circuit according to the present invention;

FIG. 4 is a schematic circuit diagram showing the constitution of the synchronous signal generator shown in FIG. 3;

FIG. 5 is a timing chart for illustrating the operational sequence of the synchronous signal generator shown in FIG. 4;

FIG. 6 is a schematic circuit diagram showing an alternative constitution of the synchronous signal generator shown in FIG. 3;

FIG. 7 is a schematic circuit diagram showing the constitution of a phase adjuster shown in FIG. 6; and

FIG. 8 is a timing chart for illustrating the operational sequence of the phase adjuster shown in FIG. 7.

### DESCRIPTION OF THE PREFERRED EMBODIMENTS

Preferred embodiments of the display drive circuit according to the present invention will now be described in detail with reference to the accompanying drawings. A display drive circuit 10 of the present embodiment includes a controller 16 and a drive section 40, and may be arranged, for instance, within a timing controller in an image display apparatus, both not shown.

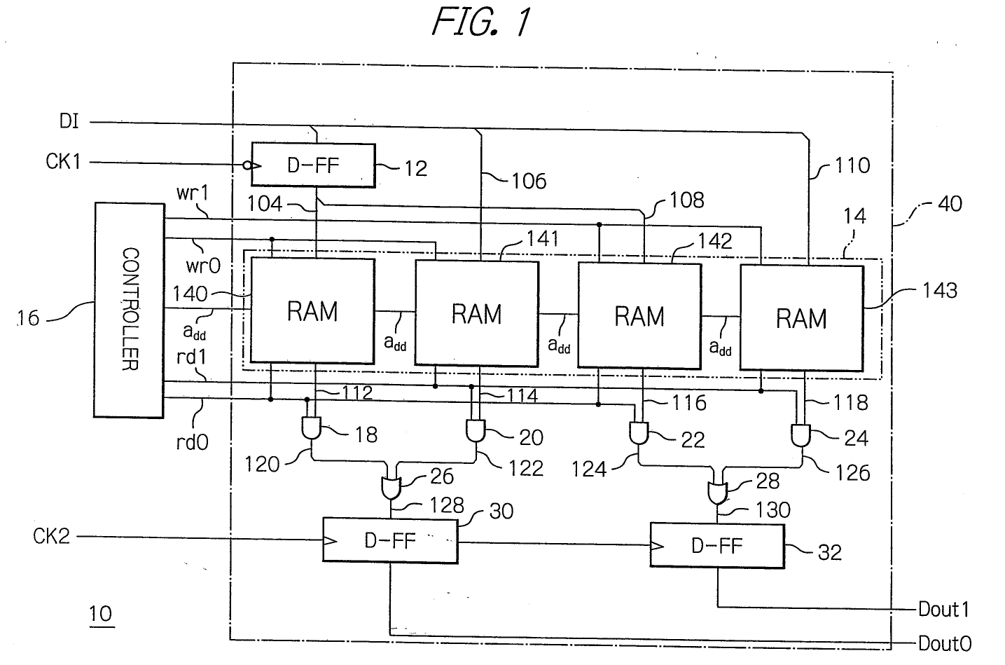

Referring to FIG. 1, input data signals DI, supplied from an image processor, not shown, are written distinctively from each other on a pixel data-by-pixel data basis into predetermined areas of a line memory 14 directly or via a delay circuit (D-FF) 12 in response to a write command provided by the controller 16 to the line memory 14. The pixel data, thus written into the line memory 14, are then read out in response to a readout command signal issued by the controller 16 to the line memory 14. The pixel data, when read out, are caused to pass one of AND gates 18, 20, 22 and 24 which is dependent upon which subsection of the line memory 14 the pixel data have been stored, and thence to corresponding one of OR gates 26 and 28 and then to associated one of delay circuits 30 and 32. The data transferred to the one delay circuit 30 are delayed and output in the form of split image data signal Dout0, while the data transferred to the other delay circuit 32 are also delayed and output in the form of split image data signal Dout1.

The image data signals Dout0 and Dout1, obtained on splitting the signal DI, as described above, are transferred to, for example, a source driver, not shown, which in turn performs signal conversion on the image data signals, which will be visualized as a picture on an image display unit, such as a liquid crystal display (LCD) panel, also not shown. The source driver and the display unit are not directly relevant to understanding the present invention and hence are not shown or described in detail.

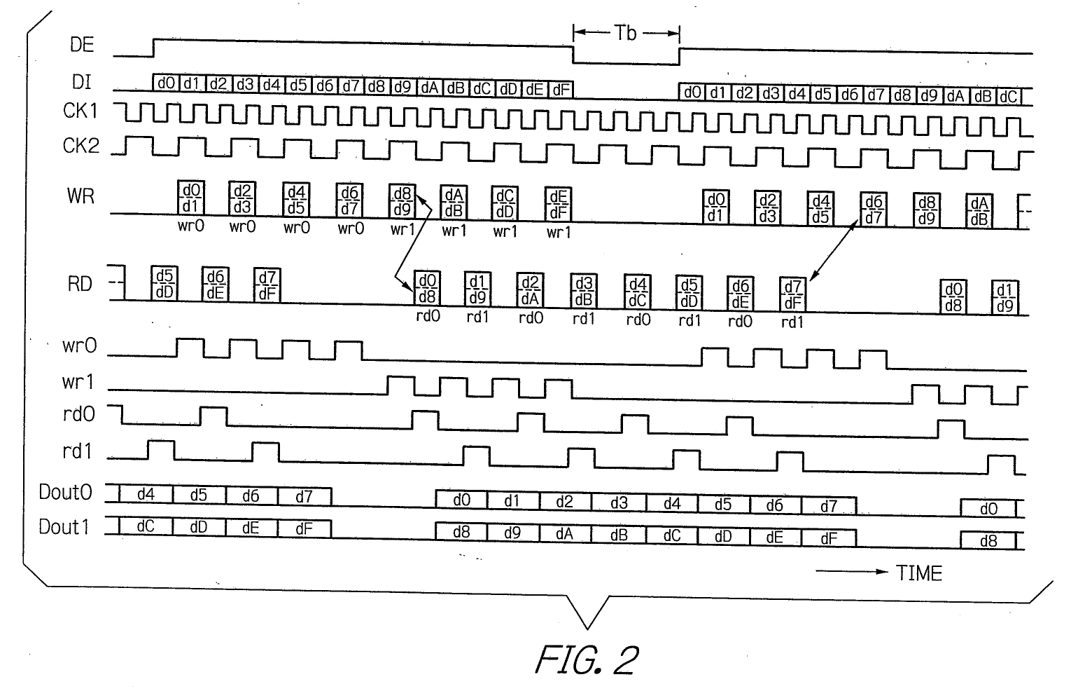

The input image data signal DI, transferred from, e.g. the image processor, is an image signal of a predetermined number of bits, such as 24 bits. The image processor transfers a data enable signal DE, FIG. 2, for enabling the image data signal DI to be received by the drive section 40. In the illustrative embodiment, the input data enable signal DE has its time interval of high (H) level effective for enabling image signal transmission. The time period during which the input signal DE is at its low (L) level is a blanking period Tb during which no information is transferred as the signal DI.

With the present embodiment, the time period during which the data enable signal DE is at its high (H) level, that is, the effective period for image signal transmission, is a period corresponding to 16 sampling clocks of a clock signal CK1 having a predetermined frequency. The blanking period, where there is no data to be transferred, is a period corresponding to four sampling clocks of the clock signal CK1. The effective period for image signal transmission and the blanking period are repeated at the predetermined cycle. It should be noted that the periods of the signal levels of the data enable signal DE are not limited to the above example.

In the illustrative embodiment, it is supposed merely for illustration that the input image data signal DI is a line signal composed of 16 pixels of data d0-dF, FIG. 2, corresponding to a horizontal scanning line in one cycle of the data enable signal DE which is the effective period of image signal transmission. In FIG. 2, the hexadecimal notation (0 to F) following legends for the pixel data is useful in deciphering whether the pixel data in question on a line signal is even-numbered data 2m or odd-numbered data 2m+1, where m is a natural number. In the following description, reference numerals of connections also denote signals on the connections.

The delay circuit 12 is, e.g. of a D (Delayed) type of flip-flops (D-FFs), which is responsive to the negative-going edge of the clock signal CK1, and is interconnected to output the input data signal DI to the line memory 14 with a delay corresponding to one clock.

The line memory 14 is an aggregate of rewritable memories which receive odd-numbered pixel data signals 106 and 110 and even-numbered pixel data signals 104 and 108, after delayed by the delay circuit 12, of the image data signal DI, and which information for a one-line signal may be stored in and read out from. In the present embodiment, the line memory is separated into four RAMs (Random Access Memories) 140, 141, 142 and 143, each of which is dedicated for storing pixel data of specific pixel positions in one horizontal line. Each of the RAMs 140 to 143 has therefore its storage capacity corresponding to one-fourth of pixel data on a horizontal line. Hence, the line memory 14 in its entirety is able to store a single line of pixel data, that is, has its capacity corresponding to one horizontal scanning period.

The RAMs 140 and 141 store the former half of the line signal of the image data signal DI on a pixel data-by-pixel basis. Of the former half part of the line signal DI, even-numbered pixel data d0, d2, d4 and d6, delayed by the delay circuit 12 by one cycle of the clock signal CK1, are supplied to a data signal input terminal 104 of the RAM 140 for storage therein. The pixel data d0, d2, d4 and d6 are conveyed in their entirety on the signal 104. Thus, signals are designated with reference numerals associated with connections on which they are conveyed. Of the same former half part of the line signal DI, odd-numbered pixel data d1, d3, d5 and d7 are supplied to a data signal input terminal 106 of the RAM 141 for storage therein. The pixel data d1, d3, d5 and d7 are thus transferred in their entirety on the signal 106.

The RAMs 142 and 143 store the latter half of the line signal of the image data signal DI also on a pixel data-by-pixel data basis. Of the latter half part of the line signal DI, even-numbered pixel data d8, dA, dC and dE, delayed by the delay circuit 12 by one cycle of the clock signal CK1, are supplied to a data signal input terminal 108 of the RAM 142 for storage therein. The pixel data d8, dA, dC and dE are transferred in their entirety by the signal 108. Of the same latter half part of the line signal DI, odd-numbered pixel data d9, dB, dD and dF are supplied to a data signal input terminal 110 of the RAM 143 for storage therein. The pixel data d9, dB, dD and dF are transferred in their entirety on the signal 110.

The controller 16 provides the line memory 14 with write command signals wr0 and wr1, an address signal a_{dd} and readout command signals rd0 and rd1. The write command signals wr0 and wr1 command writing the pixel data signals 104, 106, 108 and 110 into the memory 14. The address signal a_{dd} indicates the storage positions in the memory 14 for the pixel data signals to be transferred. The readout command signals rd0 and rd1 command reading out the pixel data signals written in the line memory 14.

The controller 16 is connected to the RAMs 140 and 141 so that the write command signal wr0 for commanding data writing will be transferred to both of the RAMs 140 and 141. At a timing when the write command signal wr0, supplied from the controller 16, goes positive, the signal 104, that is, even-numbered data of the former half of a line signal of the input image data signal DI, is written into the one RAM 140, while the signal 106, that is, odd-numbered data of the former half of the same line signal of the signal DI, is written into the other RAM 141. It should be reminded that the signal 104 has been delayed by the delay circuit 12 in the period corresponding to one clock of the clock signal CK1. It is thus possible for the controller 16 to exercise control so as to conduct storage of given pixel data in the RAM 140 concurrently with storage in the RAM 141 of pixel data transferred to the display drive circuit 10 following the given pixel data.

The controller 16 is also connected to the RAMs 142 and 143 so that the write command signal wr1 for commanding data writing will be transferred to those RAMs. At a timing when the write command signal wr1, supplied from the controller 16, goes positive, the signal 108, that is, even-numbered data of the latter half of that line signal of the input image data signal DI, is written into the RAM 142, while the signal 110, that is, odd-numbered data of the latter half of the same line signal of the signal DI, is written into the RAM 143. The signal 108 has been delayed by the delay circuit 12 in the period corresponding to one clock of the clock signal CK1. It is thus possible for the controller 16 to exercise control so as to conduct storage of a given pixel data in the RAM 142 concurrently with storage in the RAM 143 of a pixel data transferred to the display drive circuit 10 following the given pixel data.

The controller 16 continuously develops the write commend signal wr0 on its H level to the appropriate RAMs of the line memory 14, thus controlled, so that all of the pixel data of the former half of the line signal will initially be stored in the RAMs 140 and 141. Since the line signal is used, which is composed of 16 pixel data per horizontal period, one-half of the 16 pixel data, that is, eight pixels of data, are divisionally stored in the couple of RAMs. Hence, four write command signals are transferred in succession. The H-level signals wr1 are then transferred in succession until all of the pixel data of the latter half of the line signal are stored in the RAMs 142 and 143. After the pixel data for one line are written in their entirety into the appropriate RAMs, the write command stays in the blanking period until the next line signal is received by the display drive circuit 10. At this time point, one cycle of the write command signal completes. From this time on, the controller 16 will transfer the write command signal to the line memory 14 at this time interval.

The controller 16 is connected to the RAMs 140 and 142 so that the controller 16 will be able to transfer to both RAMs the readout command signal rd0 that commands the RAMs to read out data written therein. At a timing when the readout command signal rd0, supplied from the controller 16, goes positive, the RAM 140 outputs the even-numbered data of the former half of the line signal as a signal 112 in the order the even-numbered data are written in the RAM 140. On the other hand, the RAM 142 outputs the even-numbered data of the latter half of the line signal as a signal 116 in the order the data have been written in the RAM 142.

The controller 16 is connected to the RAMs 141 and 143 so that the control circuit will be able to transfer to both RAMs the readout command signal rd1 that commands the RAMs to read out data written therein. At a timing when the readout command signal rd1, supplied from the controller 16, goes positive, the RAM 141 outputs the odd-numbered data of the former half of the line signal as a signal 114 in the order the data are written in the RAM 141. On the other hand, the RAM 143 outputs the odd-numbered data of the latter half of the line signal as a signal 118 in the order the data have been written in the RAM 143.

It is noted that the controller 16 alternately transfers the H-level readout command signals rd0 and rd1 to the RAMs of the line memory 14. Specifically, the control circuit first transfers the signals rd0 to the RAMs 140 and 142, where the even-numbered pixel data have been stored, and subsequently transfers the signals rd1 to the RAMs 141 and 143, where the odd-numbered pixel data have been stored. In the present embodiment, 16 pixel data for one line are stored so that four pixel data are stored in each of the four RAMs. Thus, the controller 16 alternately transfers the signals rd0 and rd1 in this order four times in all. By alternately transferring the readout commands in this manner, the pixel data are read out in the aligned sequence in the split image data signal Dout0 or Dout1.

After all of the pixel data for one line have been read out from the appropriate RAMs, the controller 16 refrains from transferring readout commands to the line memory 14 during the period corresponding to the blanking period Tb even in the appropriate timing. At this time point, one full cycle of the readout command signals completes. Since then, the controller 16 will transfer the readout command signals to the line memory 14 at this time interval.

In the instant illustrative embodiment, the controller 16 delivers the write commands on the write command signals wr at a time when a clock signal CK2 is at its H level, and the readout commands by the readout command signals rd at a time when the clock signal CK2 is at its L level, thus data being alternately written into or read out from the line memory 14. This way of alternate data write and readout renders it possible to generate split image data signals even when routine RAM devices are used whose total memory capacity corresponds to one horizontal period as the line memory 14 rather than a dual-port RAM having its circuit size larger.

The controller 16 provides the line memory 14 with the readout command of the first time on the readout command signal rd0 in a readout command signal cycle to cause split image data to output, after having written pixel data initially transferred as a leading signal in each of the horizontal cycles of the split image data signal Dout1 that forms the latter half of one horizontal cycle of the input image data signal DI. For example, in the present embodiment, the readout command signal rd0 is transferred to the line memory 14 after having written the initial data d8 in the latter half of the line signal in the RAM 142 by the write command by the first signal wr1 in one cycle of the write command signals. By supplying the readout command signal at this timing, it is possible to efficiently read out data written into the line memory 14.

The AND gate 18 is connected to the controller 16 and the data output terminal 112 of the RAM 140 to receive the readout command signal rd0 and the readout data signal 112 from the RAM 140 in order to output a data signal 120 in case both signals are at the H level thereof. Similarly, the AND gate 20 is connected to the controller 16 and the data output terminal 114 of the RAM 141 to receive the readout command signal rd1 and a readout data signal 114 from the RAM 141 in order to output a data signal 122 in case both input signals are at the H level thereof.

The AND gate 22 is connected to the controller 16 and the data output terminal 116 of the RAM 142 to receive the readout command signal rd0 and the readout data signal 116 from the RAM 142 in order to output a data signal 124 in case both signals are at the H level thereof. Similarly, the remaining AND gate 24 is connected to the control circuit and the data output terminal 118 of the RAM 143 to receive the readout command signal rd1 and the readout data signal 118 from the RAM 143 in order to output a data signal 126 in case both input signals are at the H level thereof.

The OR gate 26 is connected to the outputs 120 and 122 of the AND gates 18 and 20, respectively to receive the readout signals 120 and 122 to output a data signal 128 in case either one of the readout signals is at its H level. Similarly, the other OR gate 28 is connected to the outputs 124 and 126 of the AND gates 22 and 24, respectively, to receive the readout signals 124 and 126 to output a data signal 130 in case either one of the input signals is at its H level.

Of course, the constitution of the circuitry is not specifically limited to the gates 18 to 28 described above. Circuit configuration other than described above or logic gates other than the AND and OR gates is applicable provided that the data signals 128 and 130 may be generated and output from the readout data signals 112, 114, 116 and 118 provided from the respective RAMs 140, 141, 142 and 143.

The delay circuit 30 is connected to the output of the OR gate 26 so as to be supplied with the data signal 128. The delay circuit 30 runs responsive to the positive-going edge of the clock signal CK2, which is obtained on frequency-dividing the signal CK1 by a frequency division ratio of two, to delay the data signal 128 by one clock to output the resultant signal as the split image data signal Dout0 as output. The split image data signal Dout0 is a signal for the former half (d0 to d7) for one line of the input image data signal DI.

The other delay circuit 32 is connected to the output of the OR gate 28 so as to be supplied with the data signal 130. The delay circuit 32 is operative in response to the positive-going edge of the clock signal CK2 to delay the data signal 130 by one clock and then to output the resultant signal as the split image data signal Dout1. The split image data signal Dout1 is a signal for the latter half (d8 to dF) for the one line of the input image data signal DI.

The operation for splitting the image signal in the display drive circuit 10 now be described with reference to the timing chart of FIG. 2.

Of the input image data signal DI, transferred from the image processor and composed of 16 pixel data d0-dF for one line, the even-numbered pixel data are transferred to the drive circuit 10 when the clock signal CK2 is at its L level. On the other hand, the odd-numbered pixel data are transferred to the circuit 10 when the clock signal CK2 becomes high in level.

The delay circuit 12 receives the input data signal DI transferred from the image processor to the display drive circuit 10. The delay circuit 12 delays the signal by one cycle of the clock signal CK1 to output the so delayed signal.

At a timing when the clock signal CK2 goes positive, the controller 16 transfers to the RAMs 140 and 141 the write command signal wr0 that requests the RAMs to write data therein. The RAM 140 responds to the command of the signal wr0 to store the pixel data d0 which is the even-numbered data delayed by the delay circuit 12. At the same time, the RAM 141 responds to the signal wr0 to store the pixel data d1 which is the data signal 106.

By the similar sequence of operation, the controller 16 delivers the H-level write command signal wr0 to the RAMs 140 and 141 until the even-numbered data are stored in their entirety in the RAM 140 and the odd-numbered data are stored in their entirety in the RAM 141. With the present embodiment, write commands are executed four times, whereby the pixel data d0, d2, d4 and d6, that is, the even-numbered pixel data of the former half of the line signal, are stored in the RAM 140, and the pixel data d1, d3, d5 and d7, that is, the odd-numbered pixel data of the former half of the line signal, are stored in the RAM 141.

After causing the pixel data of the former half of the line signal to be written in their entirety into the RAMs 140 and 141, the controller 16 transfers the H-level write command signal wr1 to the RAMs 142 and 143. The even-numbered pixel data carried on the data signal 108 transferred to the RAM 142 at this timing is the data d8, which is in turn stored in the RAM 142. On the other hand, the odd-numbered pixel data carried on the data signal 110 transferred to the RAM 143 at this timing is the data d9. Hence, the RAM 143 stores the signal data d9.

After the pixel data d8, first even-numbered for the latter half of the line signal, have been written in the RAM 142, and the pixel data d9, first odd-numbered for the latter half of the line signal, have been written in the RAM 143, in response to the command carried on the write command signal wr1, the controller 16 delivers the readout command signal rd0 to the RAMs 140 and 142 and the AND gates 18 and 22, at a timing when the clock signal CK2 becomes low in level.

Upon receipt of the readout command carried by the signal rd0 from the controller 16, the RAM 140 delivers the readout data signal 112 to the AND gate 18. The pixel data are read out in the form of signal 112 in the same sequence as the write sequence for the RAM 140. Hence, the content of the signal 112, output to the AND gate 18 responsive to the first readout command, is the data d0. In a similar manner, upon receipt of the readout command on the signal rd0, the RAM 142 delivers the readout data signal 116 to the AND gate 22. The pixel data output at this time to the AND gate 22 in the form of signal 116 are the data d8, written first in the latter half of the line signal and being the sole data written at this time in the RAM 142.

As for the inputs to the AND gate 18, the signal rd0 is at its H level, with the signal 112 being the data d0. Thus, the AND gate 18 transfers the pixel data d0 as the signal 120 to the OR gate 26. Since the output of the OR gate 26 becomes high in level in case either of its two inputs becomes high in level, the OR gate 26 delivers the pixel data d0 as the data signal 128 to the delay circuit 30. Similarly, the AND gate 22 delivers the pixel data d8 as the data signal 124 to the OR gate 28, which in turn delivers the pixel data d8 as the data signal 130 to the delay circuit 32.

At a timing when the first readout command signal rd0 reverts to its L level in one cycle, the controller 16 again delivers the H-level write command signal wr1 to the RAMs 142 and 143 to cause pixel data dA and dB to be written into the RAMs 142 and 143, respectively. At the same timing, the readout command by the readout command signal rd0 comes to close, so that signal readout by the RAMs 140 and 142 also comes to close.

At this time, the delay circuit 30 outputs the pixel data d0, the information content of the signal 128, so far delivered thereto, as the split image data signal Dout0, in synchronous with the positive-going edge of the input clock signal CK2. The delay circuit 30 keeps on to output the pixel data d0, as the signal Dout0, until next the clock signal CK2 goes positive to output a clock pulse. At the same time, the delay circuit 32 outputs the pixel data d8, the information content of the signal 130, so far delivered thereto, as the split image data signal Dout1, in synchronism with the positive-going edge of the input clock signal CK2, until next the clock signal CK2 goes positive to output a pulse of clock.

At a timing when the command of the controller 16 to write in the RAMs 142 and 143 the second pixel data dA and dB, even- and odd-numbered, respectively, of the latter half of the line signal, has come to close, the controller 16 delivers the readout command signal rd1 to the RAMs 141 and 143 as well as the AND gates 20 and 24.

On receipt of the readout command by the signal rd1 from the controller 16, the RAM 141 transfers the readout data signal 114 to the AND gate 20. The sequence of reading out the pixel data as the signal 114 is the same as writing the same data in the RAM 141, and hence the pixel data, output to the AND gate 20 by the first readout command to the RAM 141, are data d1. Similarly, on receipt of the readout command by the signal rd1, the RAM 143 transfers the readout data signal 118 to the AND gate 24. The pixel data transferred at this time to the AND gate 24 as the signal 118 are the data d9.

As for inputs to the AND gate 20, the signal rd1 is at its H level, and the signal 114 is of the data d1. Hence, the AND gate 20 delivers the pixel data d1 as the data signal 122 to the OR gate 26. Further, the OR gate 26 delivers the pixel data d1 as the data signal 128 to the delay circuit 30. Similarly, the AND gate 24 delivers the pixel data d9 as the data signal 126 to the OR gate 28, which then delivers the pixel data d9 as the data signal 130 to the delay circuit 32.

The controller 16 reverts the readout command signal rd1, which has commanded readout of the pixel data d1 and d9, to its L level, while delivering the H-level write command signal wr1, which is the third write command signal in the cycle, to cause the pixel data dC and dD to be written in the RAMs 142 and 143, respectively. At the same time, the delay circuit 30 outputs the pixel data d1, the information content of the signal 128, so far supplied thereto, as the split image data signal Dout0, in synchronism with the positive-going edge of the input clock signal CK2. The delay circuit 32 also outputs the pixel data d9, the information content of the signal 130, so far supplied thereto, as the split image data signal Dout1. The input image data signal DI continues to be output, in a split state, by the above-described sequence of operation.

In the present embodiment, immediately after the input image data signal DI has entered the blanking period Tb, the clock signal CK2 takes its L level. At this time, the controller 16 transfers the readout command signal rd1 to the RAMs 141 and 143. Since pixel data stored in the RAMs 141 and 143 are left, pixel data d3 and dB are read out from the RAMs 141 and 143, respectively. However, when the readout command carried by the outstanding signal rd1 has come to close, the signal DI is in the blanking period, so that no write command is issued from the controller 16 to the line memory 14. Hence, no data are written in the RAMs during this time period. Thus, only the readout operation is carried out on the line memory 14 during the blanking period of the data enable signal DE.

At a timing when the blanking period comes to close, and the next horizontal period commences, the first clock signal CK2 becomes high in level. At this timing, that is, when the pixel data d1 of the second line is supplied to the display drive circuit 10, the controller 16 again issues a write command on the write command signal wr0 to the RAMs 140 and 141. Thus, the first even-numbered pixel signal d0 and the first odd-numbered pixel signal d1 of the line signal, transferred anew following the delay by the delay circuit 12, are written in the RAMs 140 and 141, respectively.

During the time period when the pixel data d4 of the input data signal DI for the second line are transferred from the image processor to the display drive circuit 10, the data d7 from the RAM 141 and the data dF from the RAM 143 are read out. During the time period, the readout of the line signal, initially written in the line memory 14, comes to close.

At the timing of the positive-going edge of the next clock signal CK2, the split image data signal Dout0, having the pixel data d7 as the information, and the split image data signal Dout1, having the pixel data dF as the information, are output from the delay circuits 30 and 32, respectively. During the period when next the clock signal CK2 becomes low in level, no readout command signal is issued from the controller 16, so that no data signal is delivered at this time as input to the delay circuit 30 or 32. Thus, when next the clock CK2 goes positive, that is, during the time period when the signal DI transfers the data d7, no split image data signal is transferred by the delay circuits 30 and 32, with the split image data signals Dout0 and Dout1 then being in the blanking period.

During this time period, the pixel data d7 of the second line are written into the RAM 140. However, in the present embodiment, the pixel data d7 of the previous line has already been read out from the RAM 140 with an interval of two clocks of the clock signal CK1. There is thus no risk that the pixel data are written over by the newly delivered pixel data before read out.

The present embodiment is not to be construed in a limiting way. If the blanking period Tb is not shorter than two clocks of the clock signal CK1, that is, not shorter than one clock of the clock signal CK2, the readout data re not written over by the next line data. On the other hand, the readout delay up to Tb=2τ is acceptable, where τ is one clock period of the clock signal CK1.

In the above sequence of operation, the delay circuit 30 outputs the data of the former half of the line signal d0-d7 as the split image data signal Dout0, in the sequence of the data delivered to the drive circuit 10. On the other hand, the delay circuit 32 outputs the data of the latter half of the line signal (d8-dF) as the split image data signal Dout1, in the sequence of the data delivered to the drive circuit 10.

Thus, with the display drive circuit 10 according to the present invention, it is possible to split image data, and to output the so split image data, without increasing the circuit size, with the use of the line memory 14 having the data storage capacity one-half as small as the conventional memory, that is, the data storage capacity corresponding to one horizontal line.

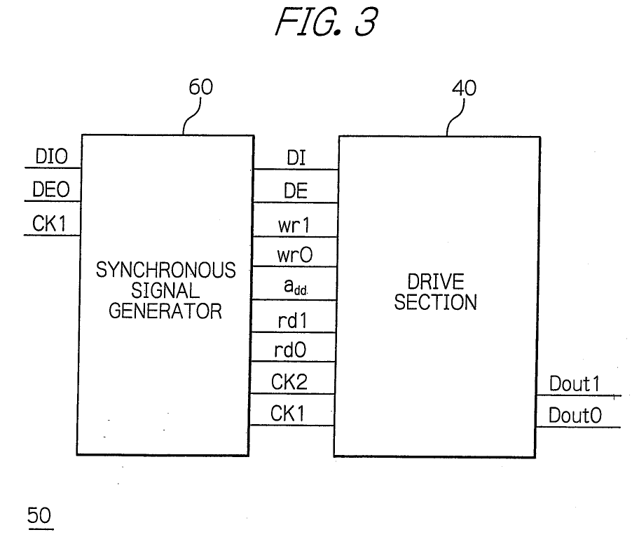

An alternative embodiment of the display drive circuit according to the present invention will now be described in detail with reference to FIGS. 3, 4 and 5. A display drive circuit 50 of the present alternative embodiment includes, as shown in FIG. 3, a synchronous signal generator 60 and a drive section 40, connected to the outputs of the synchronous signal generator 60. The drive section 40 may be the same as described above in connection with the previous embodiment shown in and described with reference to FIG. 1. The synchronous signal generator 60 generates the clock signal CK2, obtained on frequency-dividing the signal CK1 by the frequency division ratio of two, write command signals wr0 and wr1, address signal a_{dd}, and readout command signals rd0 and rd1, in time with the clock signal CK1. The signal generator 60 of the alternative embodiment includes the function of the controller 16 in the previous embodiment. The constitution and the operation of the drive section 40 are similar to those described above and hence a repetitive description thereof is dispensed with.

The display drive circuit 50 has its inputs connected to the outputs of, e.g. an image processor, not shown, while having its outputs connected to, e.g. the inputs of a source driver, not shown. When an input image data signal DI0, a data enable signal DE0 that enables transmission of the signal DI0 and a clock signal CK1 are delivered from the image processor to the drive circuit 50, the synchronous signal generator 60 delays the signal DI0 and the signal DE0 by one clock of the clock signal CK1 to compose image data signals DI and DE, respectively. These delayed signals DI and DE are transferred to the drive section 40. Based on the clock signal CK1 and the signal DE, the synchronous signal generator 60 further generates the clock signal CK2, write command signals wr0 and wr1, readout command signals rd0 and rd1 and address signal a_{dd}. The signals wr0 and wr1 command writing the image data signal DI into the line memory 14, and the signals rd0 and rd1 command reading out data stored in the line memory 14. These signals generated by the signal generator 60 are transferred to the drive section 40. Based on the signals transferred from the signal generator 60, the drive section 40 generates the split image data signals Dout0 and Dout1 in accordance with the sequence of operation described above to output the signals Dout0 and Dout1 to the source driver.

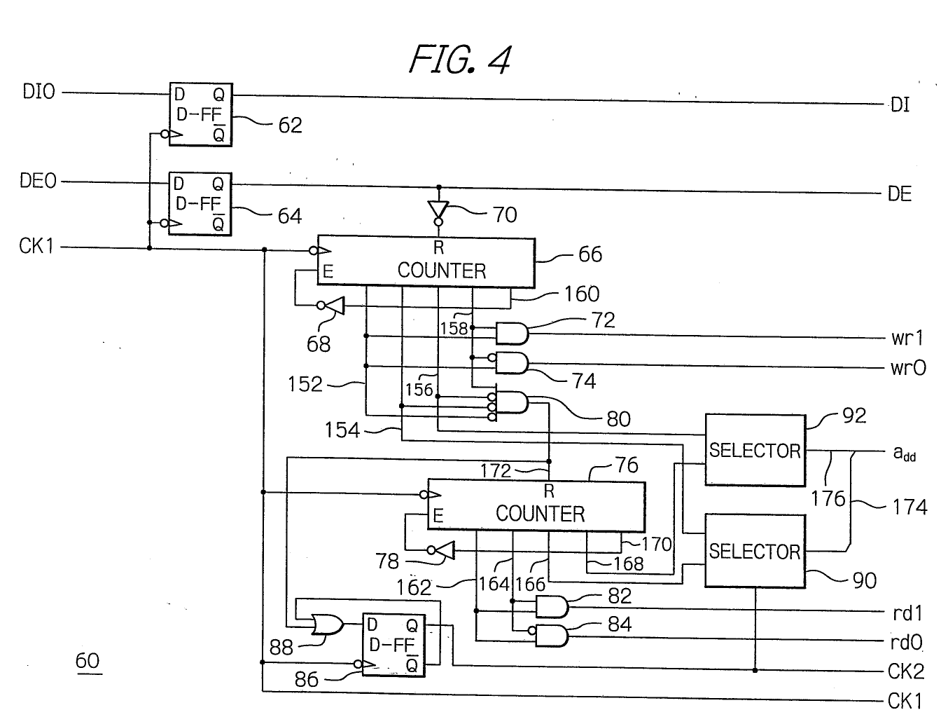

FIG. 4 shows an exemplified constitution of the synchronous signal generator 60. The signal generator 60 has a delay circuit (D-FF) 62 receiving the image data signal DI0, transferred from, e.g. the image processor, and delaying the data signal in response to the negative-going edge of the clock signal CK1 to compose an image data signal DI which is in turn output to the drive section 40.

The synchronous signal generator 60 has another delay circuit 64. The delay circuit 64 runs in operation at the timing of the negative-going edge of the clock signal CK1 and delays the data enable signal DE0, supplied from the image processor, by one clock, to compose the data enable signal DE, which is then output to the drive section 40.

The synchronous signal generator 60 includes a counter 66. The counter 66 may be, e.g. a synchronous type of 5-bit binary up-counter, which performs a counting operation in time with the negative-going edge of the clock signal CK1. The counter 66 has its input terminal for the clock signal CK1, its enable terminal E that receives an enable signal allowing for counting, and its reset terminal R that receives a reset signal for resetting the counter 66. The counter 66 outputs a count result on a signal 152 on the bit position of 2⁰, a signal 154 on the position of 2¹, a signal 156 on the position of 2², a signal 158 on the position of 2³ and a signal 160 on the position of 2⁴. Note that in the specification the representation “2ⁿ” means the n-th significant position of a binary number, where n is a natural number.

The synchronous signal generator 60 includes NOT gates or inverters 68 and 70. The NOT gate 68 is connected to receive the signal 160 and inverts its signal level to output the result in the form of enable signal on the terminal E of the counter 66. More specifically, the signal 160, when being at its L level, is inverted by the NOT gate 68 to an H-level signal only when the bit position of 2⁴ representing a count by the counter 66 is of binary zero. The so inverted signal 160 is output as an enable signal to the terminal E to allow its count operation to be enabled.

The NOT gate 70 is connected to receive the data enable signal DE and inverts its signal level to output the result to a reset terminal R of the counter 66. Specifically, during the blanking period of the signal DE, the NOT gate 70 outputs the inverted version of the signal DE to the reset terminal R of the counter 66 to reset the counter.

The synchronous signal generator 60 includes AND gates 70 and 72. The one AND gate 72 is connected so that its inputs receive the signals 152 and 158 output from the counter 66. When both the signals 152 and 158 are at the H level thereof, the gate 72 outputs the H-level write command signal wr1 to the drive section 40.

The other AND gate 74 is connected so that its inputs receive the signals 152 and 158 output from the counter 66. When the signals 152 and 158 are at the H and L levels thereof, respectively, the gate 74 outputs an H-level write command signal wr0 to the drive section 40.

Further, the synchronous signal generator 60 includes another counter 76, another NOT gate 78 and further AND gates 80, 82 and 84. The counter 76 is, e.g. a synchronous type of 5-bit binary up-counter, which performs a count operation in synchronous with the negative-going edge of the clock signal CK1. The counter 76 has its input terminal of the clock signal CK1, enable terminal E and reset terminal R. The counter 76 outputs a count result on a signal 162 on the bit position of 2⁰, a signal 164 on the position of 2¹, a signal 166 on the position of 2², a signal 168 on the position of 2³ and a signal 170 on the position of 2⁴.

The NOT gate 78 is connected to receive the signal 170 and inverts the signal level of the signal 170 to output the result as an enable signal to the terminal E of the counter 76. Specifically, the signal 170, when being its L level, is inverted by the NOT gate 78 to an H-level signal only when the bit position of 2⁴ containing a count by the counter 76 is of binary zero. The so inverted signal is output as an enable signal to the terminal E of the counter 76 to allow a count operation to be enabled.

The AND gate 80 is connected to receive the signals 152, 154, 156 and 158, output from the counter 66, and delivers an H-level signal 172 to the terminal R of the counter 76 when the signals 152, 154 and 156 are all at their L level and the signal 158 is at its H level. That is, the AND gate 80 generates a signal 172 which will be a reset signal for the counter 76.

The AND gate 82 is connected to receive the signals 162 and 164 output from the counter 76. When the signals 162 and 164 are both at the H level thereof, the AND gate 82 outputs an H-level readout command signal rd1 to the drive section 40.

The AND gate 84 is connected so that its inputs receive the signals 162 and 164 output from the counter 76. When the signals 162 and 164 are at the H and L levels thereof, respectively, the gate 84 outputs the H-level readout command signal rd0 to the drive section 40.

The synchronous signal generator 60 includes another delay circuit 86, which is connected so that the signal 172 and an inverted output of the delay circuit 86 itself will be fed back to its input D via an OR gate 88, which will now be described. The delay circuit 86 delays an input signal from the OR gate 88 in response to the negative-going edge of the input clock signal CK1 to generate and output the clock signal CK2, corresponding to a frequency-division of the signal CK1 by the frequency division ratio equal to two.

The OR gate 88 has its inputs connected to receive the signal 172 and the inverted output of the delay circuit 86 and its output connected to the input of the delay circuit 86. If either one of the two input signals is at its H level, the OR gate delivers the H-level output to the delay circuit 86.

The synchronous signal generator 60 has selectors 90 and 92 which have respective outputs 174 and 176 connected in common to the input of the drive section 40. The one selector 90 is a two-channel selector circuit that receives the output signal 154 of the counter 66, the output signal 166 of the counter 76 and the clock signal CK2. The selector 90 selects the signal 154 or 166 as an output depending on the signal level of the clock signal CK2. More specifically, when the clock signal CK2 is at its H level, the selector 90 selects the output signal 154 of the counter 66 as output data 174. When the clock signal CK2 is at its L level, the selector 90 selects the output signal 166 of the counter 76 as output data 174.

The other selector 92 is also a two-channel selector circuit that receives the output signal 156 of the counter 66, the output signal 168 of the counter 76 and the clock signal CK2, and is adapted to select the signal 156 or 168 as an output depending on the signal level of the clock signal CK2. More specifically, when the clock signal CK2 is at its H level, the selector 92 selects the output signal 156 of the counter 66 as output data 176. When the clock signal CK2 is at its L level, the selector 92 selects the output signal 168 of the counter 76 as output data 176. The output data 174 and 176 are output in the form of two-bit address signal a_{dd} to the drive section 40.

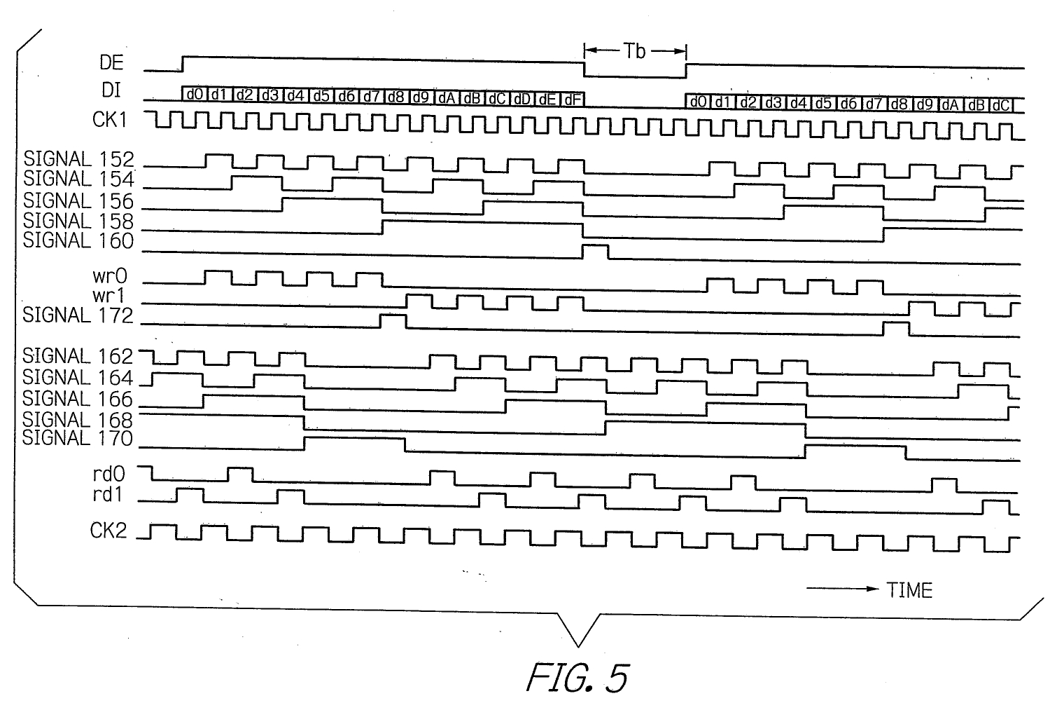

The operation of the display drive circuit 50 in the alternative embodiment and, in particular, the operation associated with signal generation by the synchronous signal generator 60, will now be described with reference to the timing chart of FIG. 5.

Of the signals delivered from the image processor to the synchronous signal generator 60, the image data signal DI0 is delayed by the delay circuit 62 by one clock of the clock signal CK1, and transferred as the image data signal DI to the drive section 40. Similarly, the data enable signal DE0 is delayed by the delay circuit 64 by one clock of the clock signal CK1, and transferred as the data enable signal DE to the drive section 40. The image data signal DI0 and the data enable signal DE0 are delayed by the delay circuits 62 and 64, respectively, by one clock of the clock signal CK1. Hence, the synchronous state of the image data signal DI and the data enable signal DE may be maintained even after the signals have passed through the synchronous signal generator 60.

When the data enable signal DE is changed from its H level to L level, the reset state of the counter 66 is canceled by level inversion by the NOT gate 70. The counter 66 then counts up responsive to the negative-going edge of the clock signal CK1, and outputs the result to the drive section 40. When the output signal 152 is at its H level and the output signal 158 is at its L level, the H-level write command signal wr0 is output from the AND gate 74. With the alternative embodiment, the H-level write command signal wr0 is output in the time period during which pieces d1, d3, d5 and d7 of the pixel data of the data signal DI, are transferred to the drive section 40. When the output signals 152 and 158 are both at the H level thereof, the write command signal wr1 is output from the AND gate 72. With the alternative embodiment, the H-level write command signal wr1 is output in the time period during which pieces d9, dB, dD and dF of the pixel data of the data signal DI are transferred to the drive section 40.

When the data enable signal DE is changed from its H level to L level, the signal level is inverted by the NOT gate 70. Hence, the count operation by the counter 66 is reset in synchronism with the negative-going edge of the clock signal CK1 applied next time to the counter 66. Thus, with the alternative embodiment, the bit position of 2⁴ indicating the signal 160, which was at its H level, reverts to its L level.

By this resetting, the enable signal, which is applied to the counter 66 and once fell to its L level, reverts to its H level. However, as long as the signal DE is in the blanking period, the counter 66 keeps on to be reset. Thus, the count-up operation is not carried out. When the blanking period comes to close and the signal DE again becomes high in level, the resetting applied so far to the counter 66 is canceled. Hence, the counter 66 again commences its count-up operation. Subsequently, the counter 66 repeats the similar sequence of operation, whereby the write command signals wr0 and wr1 are continuously generated.

With the alternative embodiment, during the time period when the pixel data d8 is transferred to the drive section 40, the signals 152, 154 and 156 are at the L level thereof, with the signal 158 being at its H level. The AND gate 80 thus delivers an H-level signal 172 to a reset terminal R of the counter 76.

On receipt of the H-level signal 172, the counter 76 initializes its count state and again counts up in synchronism with the negative-going edge of the clock signal CK1 to output the counted result. When the output signals 162 and 164 are at the H and L levels thereof, respectively, the H-level readout command signal rd0 is output from the AND gate 84. When the output signals 162 and 164 are both at the H level thereof, the H-level readout command signal rd1 is output from the AND gate 82.

When the count operation by the counter 76, initialized as described above, has started and 16 cycles of the clock signal CK1 are applied, the signal 170 for the bit position of 2⁴ becomes high in level. The signal 170 is inverted by the NOT gate 78 to its L level and is supplied in this state to the terminal E of the counter 76. Since count-up by the counter 76 ceases to be allowed, the count value is not changed subsequently at the negative-going edge of the clock signal CK1. The count value is kept until the H-level signal 172 is delivered to the terminal R of the counter 76.

If the H-level signal 172 is delivered to the terminal R of the counter 76, the count value is reset with the signal 170 reverting to L level. Hence, the enable signal, inverted by the NOT gate 78, becomes high in level to allow for a renewed count-up operation. The counter 76 then repeats the similar sequence of operation to continuously generate the readout command signals rd0 and rd1.

With the delay circuit 86, if at least either one of the signal 172 and the inverted output signal of the delay circuit 86 itself, supplied to the OR gate 88, is at its H level, an H-level signal is delivered to the delay circuit 86 from the OR gate 88. In synchronous with the negative-going edge of the clock signal CK1, the signal is delayed by one clock to generate the clock signal CK2 corresponding to a frequency-division of the signal CK1 by the frequency division ratio of two.

If the input clock signal CK2 is at its H level, the selector 90 selects the output signal 154 fed from the counter 66 to output the so selected signal as output data 174. If conversely the signal CK2 is at its L level, the selector 90 selects the output signal 166 fed from the counter 76 to output the so selected signal as output data 174.

If the input clock signal CK2 is at its H level, the selector 92 selects the output signal 156 fed from the counter 66 to output the so selected signal as output data 176. If conversely the signal CK2 is at its L level, the selector 92 selects the output signal 168 fed from the counter 76 to use it as output data 176 delivered from the selector 92. The output data 176 is output together with the output data 174 to the drive section 40 to form the two-bit address signal a_{dd}.

Those signals, generated as described above, are supplied to the drive section 40, which then operates to generate and output the split image data signals Dout0 and Dout1. The operation of the drive section 40 may be the same as described above and hence is here not repeated.

With the use of the display drive circuit 50, provided with the synchronous signal generator 60, a variety of signals, positively synchronized with the period of the clock signal CK1, may be generated by the signal generator 60 and delivered to the drive section 40. It is thus possible to control the line memory 14 more efficiently and stably to generate split image data signals.

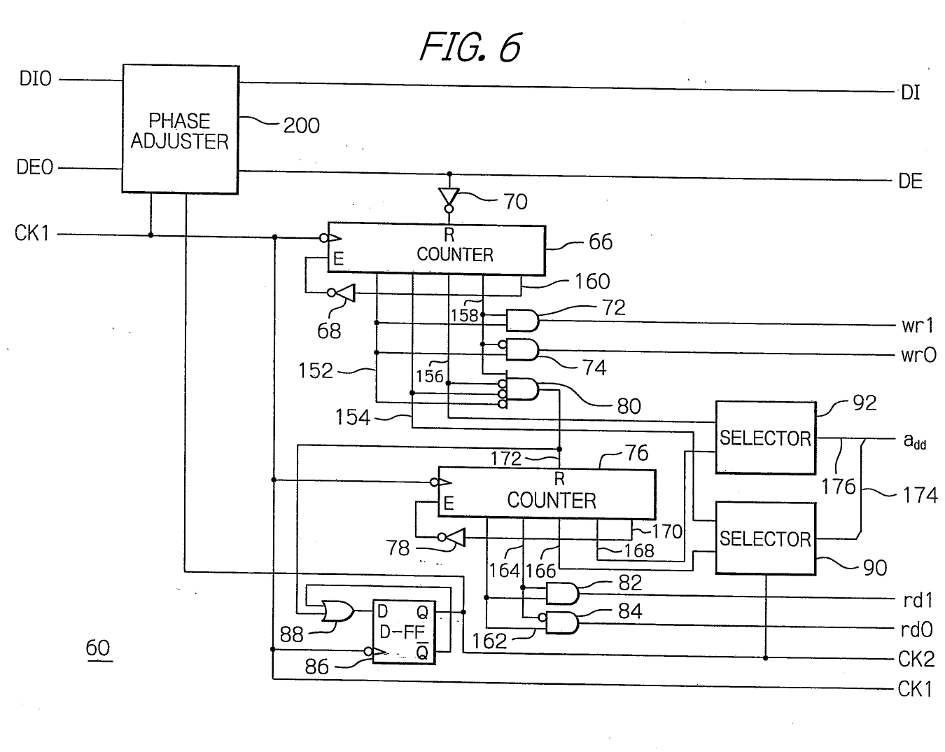

A further alternative embodiment of the display drive circuit according to the present invention will now be described with reference to FIGS. 6, 7 and 8. Like the previous embodiments, the display drive circuit 50 of the further alternative embodiment is composed of the drive section 40 and the synchronous signal generator 60. However, as seen from FIG. 6, the signal generator 60 of the instant alternative embodiment includes a phase adjuster 200, in place of the delay circuits 62 and 64 shown in FIG. 4. The phase adjuster 200 is so arranged and constructed that, in case a cycle of the data enable signal DE0 that enables transmission of the image data signal DI0, that is, the sum of one horizontal period of the image data signal DI0 and the blanking period present in this horizontal period, is made up of an odd number of clocks of the clock signal CK1, the phase adjuster 200 adjusts the cycle of the data enable signal so that the cycle of the data enable signal will be made up of an even number of clocks of the clock signal CK1. Like components described above are designated with the same reference numerals or symbols as the above-described embodiments. Hence, those components are not repetitively described in detail, and the following description will be focused on the constitution and the operation of the phase adjuster 200.

When the clock signal CK1 and the input data enable signal DE0 as well as the input image data signal DI0, having a cycle made up of an odd number of clocks of the clock signal CK1, are delivered from, e.g. the image processor to the display drive circuit 50, these signals are delivered, along with the clock signals CK2, to the phase adjuster 200 in the synchronous signal generator 60. The clock signals CK2 are generated on frequency division from the clock signal CK1 by the delay circuit 86. The phase adjuster 200 adjusts the cycles of the signals DI0 and DE0 so that these cycles will each correspond to an even number of clocks of the clock signal CK1. The phase adjuster 200 outputs the so adjusted signals DI and DE to the drive circuit 40 connected to the output of the phase adjuster 200.

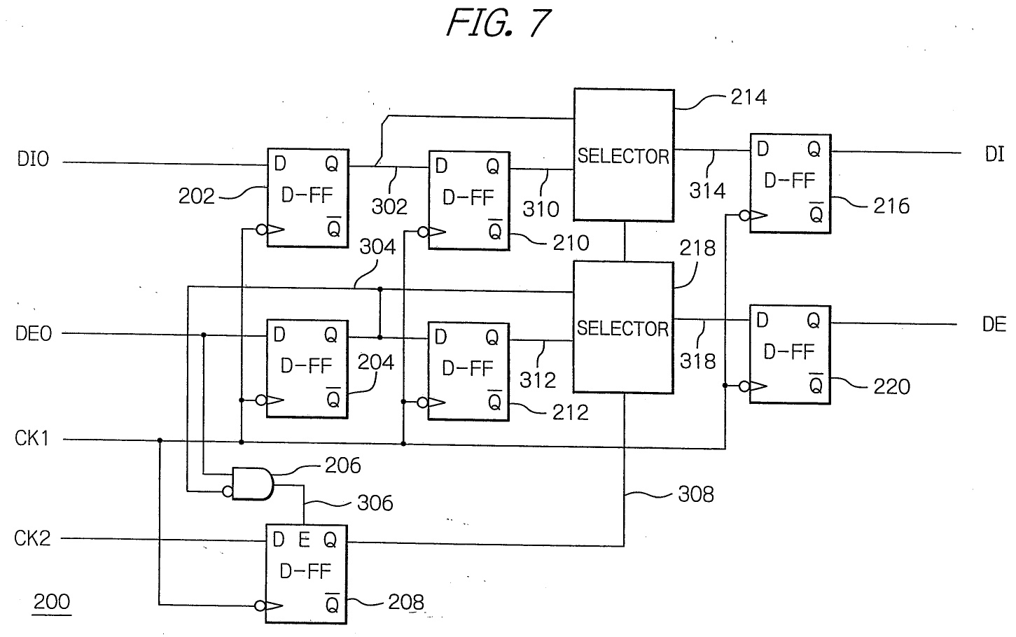

FIG. 7 shows the inner constitution of the phase adjuster 200. The adjuster 200 includes a delay circuit (D-FF) 202 which has its input port connected to an output of the image processor. The delay circuit 202 receives the image data signal DI0, delivered from the image processor, and delays the signal by one clock in time with the negative-going edge of the clock signal CK1. The delay circuit 202 outputs the so delayed signal as a data signal 302.

The phase adjuster 200 also includes another delay circuit 204 which has its input port connected to another output of, e.g. the image processor. The delay circuit 204 receives the data enable signal DE0, delivered from the image processor, and delays the signal in time with the negative-going edge of the clock signal CK1. The delay circuit 204 outputs the so delayed signal as a data signal 304.

The output 304 of the delay circuit 204 and the signal line, over which the data enable signal DE0 is transferred, are connected to an AND gate 206. The AND gate 206 outputs an H-level signal 306 when the signal DE0 is at its H level and the output signal 304 of the delay circuit 204 is at its L level.

The clock signal CK2 generated by the delay circuit 86 in the synchronous signal generator 60 is input to another delay circuit 208 in the phase adjuster 200. The delay circuit 208 then holds the input signal CK2 in synchronism with the negative-going edge of the clock signal CK1 to output a resultant signal 308. The delay circuit 208 has its enable terminal E that is connected to an output of the AND gate 206 and takes in, when actuated, the following clock pulse CK2 so as to delay the latter.

The output 302 of the delay circuit 202 stated earlier is connected to still another delay circuit 210 so as to receive the signal 302 from the delay circuit 202. The delay circuit 210 delays the data signal 302 by one clock in time with the negative-going edge of the clock signal CK1 to output a resultant data signal 310.

The output 304 of the delay circuit 204 is connected to a still further delay circuit 212 so as to receive the signal 304 from the delay circuit 204. The delay circuit 212 delays the signal 304 by one cycle in time with the negative-going edge of the clock signal CK1 to output a resulting signal 312.

The output signals 310, 302 and 308 of the delay circuits 210, 202 and 208, respectively, are input to a selector 214. The selector 214 is a two-channel selector circuit for selecting the signal 310 or 302 depending on the signal level of the signal 308. More specifically, when the signal 308 is at its H level, the selector 214 selects the output signal 310 of the delay circuit 210 to output the so selected signal on its output port 314. When the signal 308 is at its L level, the selector 214 selects the output signal 302 of the delay circuit 202 to output the so selected signal on its output port 314.

The output 314 of the selector 214 is connected to an input of a delay circuit 216. The delay circuit 216 receives the input signal 314 and delays the signal 314 by one clock, in time with the negative-going edge of the clock signal CK1, to output the so delayed signal as a data signal DI to the drive section 40.

The phase adjuster includes another selector 218 which is also a two-channel selector circuit adapted for receiving the output signals 312, 304 and 308 of the delay circuits 212, 204 and 208, respectively, as input signals, to select the signal 312 or 304 depending on the signal level of the signal 308. More specifically, when the signal 308 is at its H level, the selector 218 selects the output signal 312 of the delay circuit 212 to output the so selected signal on its output port 318. When the signal 308 is at its L level, the selector 218 selects the output signal 304 of the delay circuit 204 to output the so selected signal on its output port 318.

The output 318 of the selector 218 is connected to an input of a delay circuit 220. The delay circuit 220 receives the output signal 318 of the selector 218, and delays the signal 318 by one clock, in time with the negative-going edge of the clock signal CK1, to output the so delayed signal as a data enable signal DE to the drive section 40.

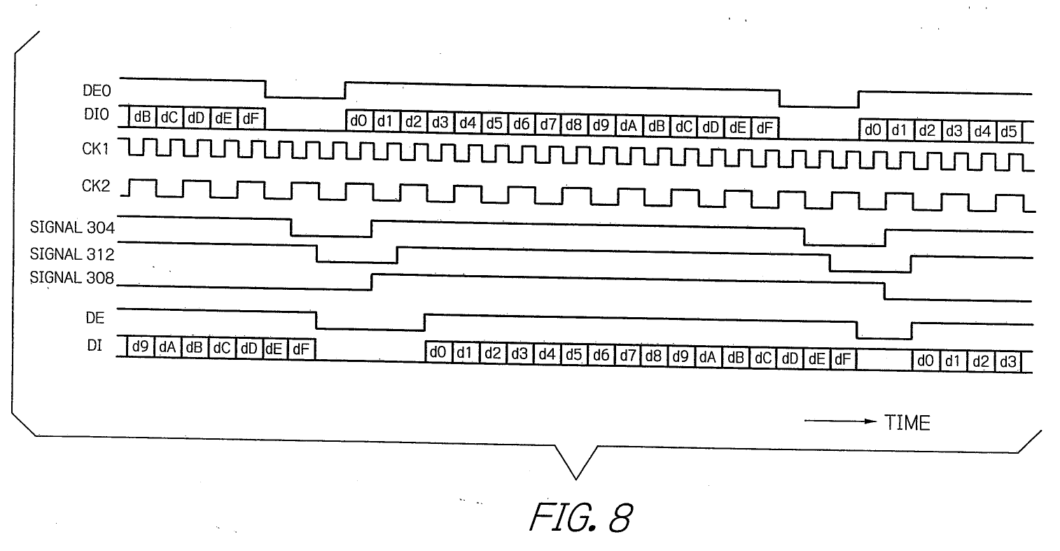

The operation of the instant alternative embodiment, in particular the operation of the phase adjuster 200, will now be described with reference to the timing chart of FIG. 8. The image data signal DI0, delivered from the image processor to the display drive circuit 50, is supplied to the delay circuit 202 in the phase adjuster 200. The delay circuit 202 delays the signal DI0 by one clock, in synchronism with the negative-going edge of the clock signal CK1, and outputs the so delayed signal as the data signal 302.

On the other hand, the data enable signal DE0, also transferred from the image processor, is supplied to the delay circuit 204 in the phase adjuster 200. The delay circuit 204 delays the signal DE0 by one clock, in time with the negative-going edge of the clock signal CK1, and outputs the so delayed signal as the data signal 304.

The output signal 304 from the delay circuit 204 and the data enable signal DE0 are delivered to the inputs of the AND gate 206. When the signal DE0 is at its H level and the signal 304 is at its L level, the AND gate 206 outputs an H-level signal 306 to the delay circuit 208. Specifically, with the instant alternative embodiment, the H-level signal 306 is output to the delay circuit 208 in time with the time period of transmission of the pixel data d0 of the image data signal DI0 to the adjuster 200.

On receipt of the H-level signal 306 on its enable terminal E, the delay circuit 208 takes in the clock signal CK2, which is input at the time of the negative-going edge of the clock signal CK1, and outputs the so taken-in signal as the signal 308. For example, if the clock signal CK2 at the timing of the negative-going edge of the clock signal CK1 is at its H level, the delay circuit 208 keeps on to output the H-level signal 308.

Since the signal 304 is resultant from delaying the signal DE0 by one cycle of the clock signal CK1, when the signal 306 takes its H level corresponds to only one cycle of the clock signal CK1 immediately after the inversion of the signal DE0 to its H level. Thus, during the next cycle of the clock signal CK1, the signal 306 reverts to its L level. The delay circuit 208 outputs the signal 308, which keeps its signal level so far output, regardless of the signal level of the clock signal CK2 at the timing of the clock signal CK1. That is, the signal level of the signal 308, once inverted, is kept during the period of one cycle of the signal DE0. If one cycle of the signal DE0 corresponds to an odd number of cycles of the clock signal CK1, the signal level of the signal 308 is kept during one cycle period of the signal DE0, and subsequently inverted, because the signal level of the clock signal CK2, having the frequency one-half as high as the clock signal CK1, is alternated during the H-level period of the signal 306.

The delay circuit 210 delays the data signal 302 by one cycle, in time with the negative-going edge of the clock signal CK1, and outputs the so delayed signal as the data signal 310. That is, the data signal 310 is delayed from the image data signal DI0 by two cycles of the clock signal CK1.

The delay circuit 212 delays the data signal 304 by one cycle, in time with the negative-going edge of the clock signal CK1, and outputs the so delayed signal as the data signal 312. That is, the data signal 312 is delayed from the data enable signal DE0 by two cycles of the clock signal CK1.

If the signal 308 is at its H level, the selector 214 selects the output signal 310 of the delay circuit 210, that is, the signal delayed from the image data signal DI0 by two cycles of the clock signal CK1, and outputs the so selected signal as the output data signal 314. If conversely the signal 308 is at its L level, the selector 214 selects the output signal 302 of the delay circuit 202, that is, the signal delayed from the image data signal DI0 by one cycle of the clock signal CK1, and outputs the so selected signal as the output data signal 314.

The delay circuit 216 delays the data signal 314 by one clock, in time with the negative-going edge of the clock signal CK1, and outputs the so delayed signal to the drive section 40 as the image data signal DI.

On the other hand, if the signal 308 is at its H level, the selector 218 selects the output signal 312 of the delay circuit 212, that is, the signal delayed from the data enable signal DE0 by two cycles of the clock signal CK1, and outputs the so delayed signal as the signal 318. If conversely the signal 308 is at its L level, the selector 218 selects the output signal 304 of the delay circuit 204, that is, the signal delayed from the signal DE0 by one cycle of the clock signal CK1, and outputs the so delayed signal as the signal 318.

The delay circuit 220 delays the data signal 318 by one clock, at a timing of the negative-going edge of the clock signal CK1, and outputs the so delayed signal as the data enable signal DE to the drive section 40 and to the NOT gate 70 which is connected to the enable input terminal of the counter 66.

The operation of the synchronous signal generator 60 and the drive section 40 after outputting the signal DE and the signal DI, thus phase adjusted, to the NOT gate 70 and to the drive section 40, is similar to that described above, and hence is not here repeated.

With the phase adjustment adjuster 200 incorporated in this way into the synchronous signal generator 60, even when the image data signal DI0 and the data enable signal DE0 have one cycle corresponding to an odd number of clocks of the clock signal CK1, it is possible to convert the signals DI0 and DE0 respectively to data signal DI and the data enable signal DE, which have one cycle corresponding to an even number of clocks of the clock signal CK1. Further, write and readout command signals, generated based on the adjusted signal DE, can be alternately delivered to the drive section 40. Thus, with the display drive circuit 50, the timing when the command signals are delivered to the line memory 14 is kept at the same timing as the timing of data transmission. It is therefore possible for the display drive circuit, as improved in stability, to generate split image data signals and to deliver the so generated signals to the display unit.

A method for splitting a picture for reducing the transfer speed to a source driver to one half has been described above which is directed as an example to the illustrative embodiments of a drive circuit controlling a line memory in a timing controller. The present invention is not limited to the specific type of drive circuit, but may, for instance, be applied to circuits or methods used for driving any types of display devices, such as for controlling a line memory in order to split a display screen and perform image signal processing in parallel.

In accordance with an aspect of the present invention, a method of driving an image display device with a plurality of sets of split image signals produced by splitting an input image data signal in a horizontal period containing a predetermined number of pixel data signals for displaying an image comprises: a storage step of writing the pixel data signals of the horizontal period on a pixel-by-pixel basis into a memory, and of reading out the pixel data signals stored from the memory; a step of controlling said storage step to alternately write in and read out the pixel data signals; and a step of controlling said storage step to commence to read out the pixel data signals of the horizontal period after having written the pixel data signals output as a first signal of the split image data signals in the horizontal period in respect of each of the plurality of sets of split image signals.

The method further comprises a synchronous signal generating step of generating, in synchronism with a clock signal, a write command signal that causes said storage step to store the pixel data signals, and a readout command signal that causes said storage step to develop the pixel data signals.

The method further comprises a phase adjustment step of adjusting a phase of the image data signal so as to convert, when a sum of the horizontal period and a blanking period between the horizontal period and a neighboring horizontal period corresponds to an odd number of clocks of the clock signal, the sum of the horizontal period and the blanking period to an even number of clocks of the clock signal.

The entire disclosure of Japanese patent application No. 2008-004870 filed on Jan. 11, 2008, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A display drive circuit for driving an image display device with a plurality of sets of split image signals produced by splitting an input image data signal in a horizontal period containing a predetermined number of pixel data signals for displaying an image, comprising:
a memory having a total memory capacity corresponding to at least the horizontal period for storing the pixel data signals and developing the pixel data signals stored; and
a controller for controlling said memory to alternately write in and read out the pixel data signals to and from said memory,
said controller controlling said memory to commence to read out the pixel data signals of the horizontal period from said memory after having written into said memory the pixel data signals output as a first signal of the split image data signals in the horizontal period in respect of each of the plurality of sets of split image signals.

2. The display drive circuit in accordance with claim 1, further comprising a synchronous signal generator operative in synchronism with a clock signal for generating a write command signal that causes said memory to store the pixel data signals, and a readout command signal that causes said memory to develop the pixel data signals.

3. The display drive circuit in accordance with claim 2, further comprising a phase adjuster for adjusting a phase of the image data signal so as to convert, when a sum of the horizontal period and a blanking period between the horizontal period and a neighboring horizontal period corresponds to an odd number of clocks of the clock signal, the sum of the horizontal period and the blanking period to an even number of clocks of the clock signal.
